(19) United States
(12) Patent Application Publication
(10) Pub. No.: US 2002/0063214 A1
(43) Pub. Date: May 30, 2002

(54) Optoelectronic microelectronic fabrication with infrared filter and method for fabrication thereof

(75) Inventors: Yu-Kung Hsiao, Yang-Mei (TW); Chih-Kung Chang, Chu-Tung (TW); Fu-Tien Weng, Taw-Yuan (TW); Chung-Sheng Hsiung, Hsinchu (TW); Bii-Jung Chang, Hsin-Chu (TW); Kuo-Liang Lu, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co. Ltd.

(21) Appl. No.: 09/725,973

(22) Filed: Nov. 29, 2000

(51) Int. Cl. G01J 5/20

(52) U.S. Cl. 250/338.4; 438/65

(57) ABSTRACT

Within both a method for fabricating an optoelectronic microelectronic fabrication and the optoelectronic microelectronic fabrication fabricated in accord with the method for fabricating the optoelectronic microelectronic fabrication there is first provided a substrate having formed therein a minimum of one photoactive region which is sensitive to infrared radiation. There is also formed over the substrate and in registration with the minimum of one optically active region a minimum of one microlens layer. Similarly, there is also formed interposed between the substrate and the minimum of one microlens layer an infrared filter layer, wherein the infrared filter is not formed contacting the substrate. The method provides that the optoelectronic microelectronic fabrication is fabricated with enhanced optical sensitivity.

### BACKGROUND OF THE INVENTION

1. Field of the Invention

The present invention relates generally to methods for fabricating optoelectronic microelectronic fabrications. More particularly, the present invention relates to methods for fabricating, with enhanced optical sensitivity, optoelectronic microelectronic fabrications.

2. Description of the Related Art

Microelectronic fabrications are formed from microelectronic substrates over which are formed patterned microelectronic conductor layers which are separated by microelectronic dielectric layers. Within the general art of microelectronic fabrication, there exist microelectronic fabrications whose operation is based solely upon electrical signal storage and processing characteristics of microelectronic devices and microelectronic circuits formed upon a microelectronic substrate. Examples of such microelectronic fabrications typically include semiconductor integrated circuit microelectronic fabrications and ceramic substrate packaging microelectronic fabrications. Similarly, there also exists within the general art of microelectronic fabrication microelectronic fabrications whose operation is predicated upon a codependent transduction, storage and/or processing of optical and electrical signals while employing optoelectronic microelectronic devices formed upon a microelectronic substrate. Examples of such optoelectronic microelectronic fabrications typically include, but are not limited to: (1) solar cell optoelectronic microelectronic fabrications, as well as; (2) image array optoelectronic microelectronic fabrications, such as but not limited to: (a) sensor image array optoelectronic microelectronic fabrications (i.e. color filter sensor image arrays), as well as: (b) display image array optoelectronic microelectronic fabrications (i.e. flat panel display image arrays). Sensor image array optoelectronic microelectronic fabrications find common usage in advanced consumer products such as digital cameras, while display image array optoelectronic microelectronic fabrications are well recognized and commonly employed as visual interface elements within mobile computers.

While the level of complexity and integration of both purely electronic microelectronic fabrications and optoelectronic microelectronic fabrications continues to increase, fabrication of advanced optoelectronic microelectronic fabrications often provides unique fabrication challenges insofar as fabrication of advanced optoelectronic microelectronic fabrications requires attention to both the optical properties and the electrical properties of materials which are employed in forming such advanced optoelectronic microelectronic fabrications. For example, of the problems which are commonly encountered when fabricating advanced optoelectronic microelectronic fabrications, such as but not limited to advanced image array optoelectronic microelectronic fabrications, problems in providing enhanced optical sensitivity are often encountered.

It is thus towards the goal of forming advanced optoelectronic microelectronic fabrications, such as but not limited to advanced image array optoelectronic microelectronic fabrications, with optimal optical sensitivity, that the present invention is directed.

Various optoelectronic microelectronic fabrication methods and/or resulting optoelectronic microelectronic fabrication structures have been disclosed in the art of optoelectronic microelectronic fabrication for forming optoelectronic microelectronic fabrications with desirable properties within the art of optoelectronic microelectronic fabrication.

For example, Collette, in U.S. Pat. No. 5,570,146, discloses an optoelectronic microelectronic image recording device which may be employed for efficiently recording an image while employing the optoelectronic microelectronic image recording device. To realize the foregoing object, the optoelectronic microelectronic image recording device employs a tri-linear scanning sensor image array optoelectronic microelectronic fabrication positioned and scanned within a focal plane of an otherwise conventional view camera, in place of a photographic film plate positioned and exposed within the focal plane of the otherwise conventional view camera.

In addition, Jedlicka et al., in U.S. Pat. No. 5,604,362, disclose a semiconductor color filter sensor image array optoelectronic microelectronic fabrication having an attenuated susceptibility for generation and detection of spurious optical signals. To realize the foregoing object, the semiconductor sensor image array optoelectronic microelectronic fabrication employs: (1) an infrared absorbing filter layer formed upon a semiconductor surface of the semiconductor sensor image array optoelectronic microelectronic fabrication other than a bond pad surface of the semiconductor sensor image array optoelectronic microelectronic fabrication; in conjunction with (2) a visible absorbing filter layer formed over portions of the semiconductor sensor image array optoelectronic microelectronic fabrication other than: (a) a direct sensing portion of the semiconductor sensor image array optoelectronic microelectronic fabrication; and (b) the bond pad surface of the semiconductor integrated circuit microelectronic fabrication.

Finally, Jedlika et al., in U.S. Pat. No. 5,808,297, disclose a semiconductor color filter sensor image array optoelectronic microelectronic fabrication which provides for independent in-line testing of color filter layer characteristics of color filter layers employed within the semiconductor color filter sensor image array optoelectronic microelectronic fabrication. To realize the foregoing object, the semiconductor color filter sensor image array optoelectronic microelectronic fabrication comprises in addition to an active sensing region a reflective test surface region, wherein the reflective test surface region has formed thereupon a series of patterned color filter test layers formed simultaneously with a series of patterned color filter operative layers formed within the active sensing region of the semiconductor color filter sensor image array optoelectronic microelectronic fabrication.

Desirable in the art of optoelectronic microelectronic fabrication are additional methods and materials which may be employed for forming optoelectronic microelectronic fabrications, such as but not limited to image array optoelectronic microelectronic fabrications, with enhanced optical sensitivity.

It is towards the foregoing object that the present invention is directed.

### SUMMARY OF THE INVENTION

A first object of the present invention is to provide a method for fabricating an optoelectronic microelectronic fabrication.

A second object of the present invention is to provide a method for fabricating an optoelectronic microelectronic fabrication in accord with the first object of the present invention, where the optoelectronic microelectronic fabrication is fabricated with enhanced optical sensitivity.

A third object of the present invention is to provide a method for fabricating an optoelectronic microelectronic fabrication in accord with the first object of the present invention and the second object of the present invention, wherein the method is readily commercially implemented.

In accord with the objects of the present invention, there is provided by the present invention a method for fabricating an optoelectronic microelectronic fabrication, and an optoelectronic microelectronic fabrication fabricated in accord with the method for fabricating the optoelectronic microelectronic fabrication. To practice the method of the present invention, there is first provided a substrate having formed therein a minimum of one optically active region which is sensitive to infrared radiation. There is also formed over the substrate and in registration with the minimum of one optically active region a minimum of one microlens layer. Finally, there is also formed interposed between the substrate and the minimum of one microlens layer an infrared filter layer, wherein the infrared filter is not formed contacting the substrate.

The method for fabricating the optoelectronic microelectronic fabrication in accord with the present invention contemplates the optoelectronic microelectronic fabrication fabricated in accord with the method for fabricating the optoelectronic microelectronic fabrication in accord with the present invention.

There is provided by the present invention a method for fabricating an optoelectronic microelectronic fabrication, where the optoelectronic microelectronic fabrication is fabricated with enhanced optical sensitivity. The present invention realizes the foregoing object by employing when fabricating an optoelectronic microelectronic fabrication comprising a substrate having formed therein a optically active region sensitive to infrared radiation, and where the substrate in turn has formed thereover a microlens layer in registration with the optically active region, an infrared filter layer interposed between the substrate and the microlens layer, but not formed contacting the substrate.

The method of the present invention is readily commercially implemented. The present invention employs methods and materials as are otherwise generally known in the art of optoelectronic microelectronic fabrication, and otherwise more specifically known in the art of image array optoelectronic microelectronic fabrication, but employed within the context of a specific ordering to provide the present invention. Since it is thus a specific ordering of methods and materials which provides at least in part the present invention, rather than the existence of methods and materials which provides the present invention, the method of the present invention is readily commercially implemented.

### BRIEF DESCRIPTION OF THE DRAWING

The objects, features and advantages of the present invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic cross-sectional diagram generally illustrating a color filter diode sensor image array optoelectronic microelectronic fabrication which may further be fabricated in accord with the present invention.

FIG. 2 shows a schematic cross-sectional diagram more specifically illustrating a color filter diode sensor image array optoelectronic microelectronic fabrication which is further fabricated in accord with the present invention.

FIG. 3 shows a graph of Transmittance versus Wavelength for a color filter diode sensor image array optoelectronic microelectronic fabrication not fabricated in accord with the present invention.

FIG. 4 shows a graph of Transmittance versus Wavelength for a color filter diode sensor image array optoelectronic microelectronic fabrication fabricated in accord with the present invention.

### DESCRIPTION OF THE PREFERRED EMBODIMENT

The present invention provides a method for fabricating an optoelectronic microelectronic fabrication, where the optoelectronic microelectronic fabrication is fabricated with enhanced optical sensitivity. The present invention realizes the foregoing object by employing when fabricating the optoelectronic microelectronic fabrication, and interposed between: (1) a substrate having formed therein a photoactive region which is sensitive to infrared radiation; and (2) a microlens layer formed over the substrate and in registration with the optically active region, an infrared filter layer, wherein the infrared filter layer is not formed contacting the substrate.

Although the preferred embodiment of the present invention illustrates the present invention within the context of fabricating, with enhanced optical sensitivity, a semiconductor color filter diode sensor image array optoelectronic microelectronic fabrication, the present invention may be employed for fabricating, with enhanced optical sensitivity, optoelectronic microelectronic fabrications including but not limited to semiconductor optoelectronic microelectronic fabrications and non-semiconductor optoelectronic microelectronic fabrications (either of which has formed within a substrate a photoactive region which is sensitive to infrared radiation), as well as image array optoelectronic microelectronic fabrications and non-image array optoelectronic microelectronic fabrications (either of which being color filter based or non color filter based), where the image array optoelectronic microelectronic fabrications include but are not limited to sensor image array optoelectronic microelectronic fabrications as well as display image array optoelectronic microelectronic fabrications.

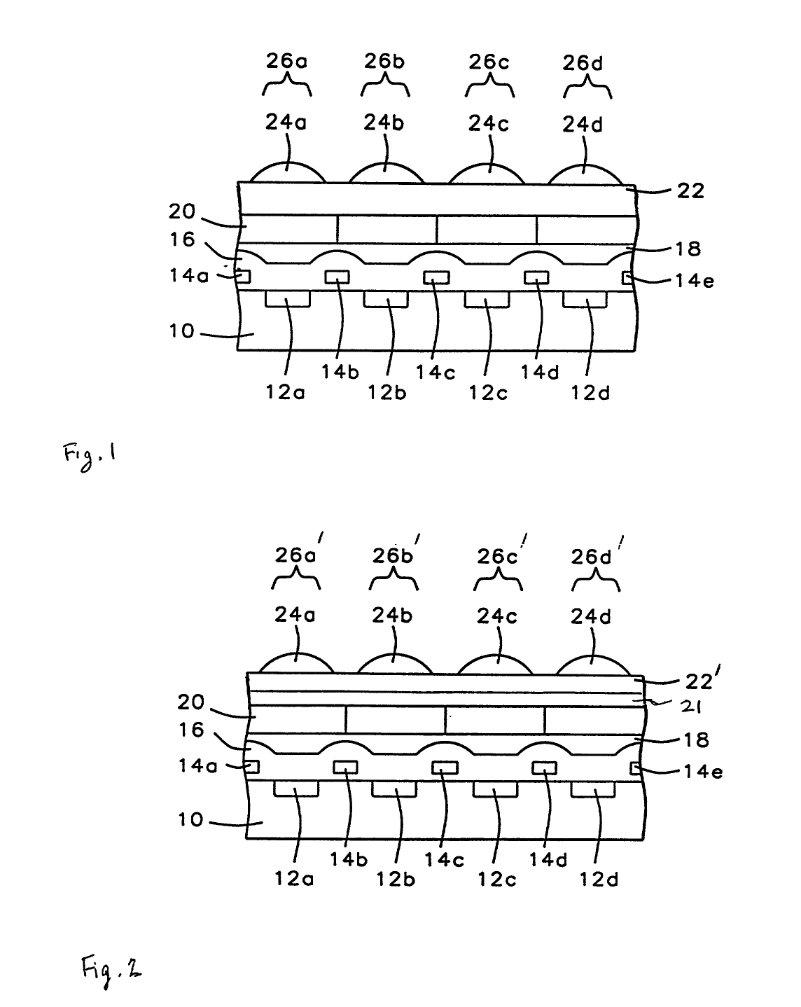

Referring now to FIG. 1, there is shown a schematic cross-sectional diagram generally illustrating a color filter diode sensor image array optoelectronic microelectronic fabrication which may further be fabricated in accord with the present invention.

Shown within FIG. 1, in a first instance, is a substrate 10 having formed therein a series of photoactive regions 12a, 12b, 12c and 12d.

Within the preferred embodiment of the present invention with respect to the substrate 10, the substrate 10 is typically and preferably a silicon semiconductor substrate, and within the preferred embodiment of the present invention with respect to the series of photoactive regions 12a, 12b, 12c and 12d, the series of photoactive regions 12a, 12b, 12c and 12d is typically and preferably a series of photodiode regions within the silicon semiconductor substrate. However, as noted above, the present invention provides value in general within the context of a substrate having formed therein a series of photoactive regions, wherein the series of photoactive regions is sensitive to infrared radiation.

Typically and preferably, the silicon semiconductor substrate which comprises the substrate 10 will have an N- or P-doping, while the series of photodiode regions which comprises the series of photoactive regions 12a, 12b, 12c and 12d will typically and preferably have a complementary P+ or N+ doping. Although FIG. 1 illustrates the substrate 10 as a flat substrate having the photoactive regions 12a, 12b, 12c and 12d formed contiguously therein, it is understood by a person skilled in the art that the photoactive regions 12a, 12b, 12c and 12d may also be formed topographically within the substrate 10, and the substrate 10 may also have formed therein additional appropriate layers and structures, such as but not limited to channel stop layers and structures, as are needed to adequately isolate the series of photoactive regions 12a, 12b, 12c and 12d.

Shown also within FIG. 1 formed upon the substrate 10 including the series of photoactive regions 12a, 12b, 12c and 12d of the substrate 10 is a blanket passivation layer 16 which has formed therein at locations alternating with the series of photoactive regions 12a, 12b, 12c and 12d a series of vertical patterned conductor layers 14a, 14b, 14c, 14d and 14e. The series of vertical patterned conductor layers 14a, 14b, 14c, 14d and 14e typically serves as a first directional charge collection array within the color filter diode sensor image array optoelectronic microelectronic fabrication whose schematic cross-sectional diagram is illustrated in FIG. 1, while the blanket passivation layer 16 serves to separate the vertical patterned conductor layers 14a, 14b, 14c, 14d and 14e from the substrate 10.

Within the preferred embodiment of the present invention, the blanket passivation layer 16 is typically and preferably formed of a passivation material which is transparent to incident electromagnetic radiation for whose detection and classification the color filter diode sensor image array optoelectronic microelectronic fabrication whose schematic cross-sectional diagram is illustrated in FIG. 1 is designed. Typically and preferably, the blanket passivation layer 16 is formed of a passivation material selected from the group including but not limited to silicon oxide passivation materials, silicon nitride passivation materials, silicon oxynitride passivation materials and composites thereof. Similarly, within the preferred embodiment of the present invention, the vertical patterned conductor layers 14a, 14b, 14c, 14d and 14e are each formed of a conductor material as is similarly conventional in the art of optoelectronic microelectronic fabrication, such conductor materials being selected from the group including but not limited to metal, metal alloy, doped polysilicon and polycide (doped polysilicon/metal silicide stack) conductor materials.

Shown also within FIG. 1 formed upon the blanket passivation layer 16 is a blanket planarizing layer 18, and there is similarly also shown within FIG. 1 formed upon the blanket planarizing layer 18 a blanket color filter layer 20. Within the preferred embodiment of the present invention, the blanket planarizing 18 layer and the blanket color filter layer 20 may be formed employing methods and materials as are conventional in the art of optoelectronic microelectronic fabrication. Typically and preferably, the blanket planarizing layer 18 is formed of a planarizing material which, similarly with the blanket passivation layer 16, is transparent to a spectrum of electromagnetic radiation whose detection and classification is effected while employing the color filter diode sensor image array optoelectronic microelectronic fabrication whose schematic cross-sectional diagram is illustrated in FIG. 1. Such planarizing materials may include, but are not limited to spin-on-glass (SOG) planarizing materials and spin-on-polymer (SOP) planarizing materials (such as, but not limited to photoresist spin-on-polymer (SOP) planarizing materials). For the preferred embodiment of the present invention, the blanket planarizing layer 18 is preferably formed of a spin-on-glass (SOG) planarizing material, preferably formed to a thickness of from about 16000 to about 20000 angstroms upon the blanket passivation layer 16.

Similarly, within the preferred embodiment of the present invention with respect to the blanket color filter layer 20, the blanket color filter layer 20 is typically and preferably formed employing methods and materials as are conventional in the art of optoelectronic microelectronic fabrication, wherein the methods and materials provide the blanket color filter layer 20 typically and preferably formed of a series of adjacent and evenly areally distributed patterned red color filter layers, patterned green color filter layers and patterned blue color filter layers.

Finally, there is shown in FIG. 1 formed upon the blanket color filter layer 20 a blanket spacer layer 22 having formed spaced thereupon a series of patterned microlens layers 24a, 24b, 24c and 24d. Within the preferred embodiment of the present invention, the blanket spacer layer 22 is preferably formed of a material which is intended to separate the series of patterned microlens 24a, 24b, 24c and 24d from the blanket color filter layer 20 and provide optimal focusing of the series of patterned microlens layers 24a, 24b, 24c and 24d with respect to the series of photoactive regions 12a, 12b, 12c and 12d formed within the substrate 10. Similarly with the blanket passivation layer 16 and the blanket planarizing layer 18, the blanket spacer layer 22 may be formed of spacer materials which are transparent to a spectrum of incident electromagnetic radiation whose detection and classification is effected by the color filter diode sensor image array optoelectronic microelectronic fabrication whose schematic cross-sectional diagram is illustrated in FIG. 1. Also similarly with the blanket passivation layer 16, the blanket spacer layer 22 may also be formed from a spacer material selected from the group consisting of silicon oxide materials, silicon nitride materials, silicon oxynitride materials, as well as spin-on-polymer (SOP) materials, and composites thereof. Typically and preferably, the blanket spacer layer 22 is formed to a thickness of from about 16000 to about 20000 angstroms upon the blanket color filter layer 20.

Finally, with respect to the series of patterned microlens layers 24a, 24b, 24c and 24d, the series of patterned microlens layers 24a, 24b, 24c and 24d is, as is conventional in the art of optoelectronic microelectronic fabrication, formed of a patterned photoresist material of appropriate optical properties, where the patterned photoresist layer is then thermally reflowed to form the series of patterned microlens layers 24a, 24b, 24c and 24d of convex shape, as illustrated within the schematic cross-sectional diagram of the color filter diode sensor image array optoelectronic microelectronic fabrication whose schematic cross-sectional diagram is illustrated in FIG. 1.

As is illustrated within the schematic cross-sectional diagram of FIG. 1, each portion of the color filter diode sensor image array optoelectronic microelectronic fabrication whose schematic cross-sectional diagram is illustrated in FIG. 1 which includes a patterned microlens layer 24a, 24b, 24c or 24d, in conjunction with a corresponding photoactive region 12a, 12b, 12c or 12d of the substrate 10 comprises an active pixel element 26a, 26b, 26c or 26d of the color filter diode sensor image array optoelectronic microelectronic fabrication.

Referring now to FIG. 2, there is shown a schematic cross-sectional diagram illustrating, as predicated upon the color filter diode sensor image array optoelectronic microelectronic fabrication whose schematic cross-sectional diagram is illustrated in FIG. 1, a color filter diode sensor image array optoelectronic microelectronic fabrication fabricated in accord with the present invention.

Shown in FIG. 2 is a schematic cross-sectional diagram of a color filter diode sensor image array optoelectronic microelectronic fabrication otherwise equivalent to the color filter diode sensor image array optoelectronic microelectronic microelectronic fabrication whose schematic cross-sectional diagram is illustrated in FIG. 1, but wherein the blanket spacer layer 22 has been replaced with a thinned blanket spacer layer ₂₂′ in turn having formed therebeneath a blanket infrared filter layer 21, to thus also provide within the preferred embodiment of the present invention in the alternative of the series of active pixel elements 26a, 26b, 26c and 26d as illustrated within the color filter diode sensor image array optoelectronic microelectronic fabrication whose schematic cross-sectional diagram is illustrated in FIG. 1 a series of infrared filtered active pixel elements 26a′, 26b′, 26c′ and 26d′.

As will be illustrated within the context of the examples which follow, the series of infrared filtered active pixel elements 26a′, 26b′, 26c′ and 26d′ as illustrated within the color filter sensor image array optoelectronic microelectronic fabrication whose schematic cross-sectional diagram is illustrated in FIG. 2 exhibits in comparison with the series of active pixel elements 26a, 26b, 26c and 26d as illustrated within the color filter diode sensor image array optoelectronic microelectronic fabrication whose schematic cross-sectional diagram is illustrated in FIG. 1, enhanced optical sensitivity.

As is further understood by a person skilled in the art, and within the context of the color filter diode sensor image array optoelectronic microelectronic fabrication whose schematic cross-sectional diagram is illustrated in FIG. 2 in comparison with the color filter diode sensor image array optoelectronic microelectronic fabrication whose schematic cross-sectional diagram is illustrated in FIG. 1, a thickness of the thinned blanket spacer layer 22′ is adjusted within the context of a thickness of the blanket infrared filter layer 21 such that the optical focus properties of the color filter diode sensor image array optoelectronic microelectronic fabrication whose schematic cross-sectional diagram is illustrated in FIG. 2 are uncompromised in comparison with the optical focus properties of the color filter diode sensor image array optoelectronic microelectronic fabrication whose schematic cross-sectional diagram is illustrated in FIG. 1. Thus, within the preferred embodiment of the present invention wherein the blanket spacer layer 20 as illustrated within the schematic cross-sectional diagram of FIG. 1 is formed to a thickness of from about 16000 to about 20000 angstroms, the thinned blanket spacer layer 22′ is typically and preferably formed to a thickness of from about 10000 to about 20000 angstroms and the blanket infrared filter layer 21 is typically and preferably formed to a complementary thickness of from about 10000 to about 15000 angstroms.

Within the preferred embodiment of the present invention with respect to the blanket infrared filter layer 21, the blanket infrared filter layer 21 may be formed of infrared filter materials as are conventional in the art of microelectronic fabrication, and will typically and preferably include spin-on-polymer (SOP) infrared filter materials, such as are available, for example and without limitation, from JSR, spin-on polymer (SOP) infrared filter materials.

Similarly, as is further understood by a person skilled in the art, given an appropriate active infrared filtering material concentration within an infrared filtering material from which is formed the blanket infrared filtering layer 21, the blanket infrared filtering layer 21 may be formed of a sufficient thickness to appropriately replace entirely the blanket spacer layer 22.

Similarly, as is further understood by a person skilled in the art, it is also plausible within the context of the present invention that in the alternative of, or as an adjunct to, substituting the blanket infrared filter layer 21 for either a portion of the blanket spacer layer 22 or the entirety of the blanket spacer layer 22, there may also be employed an alternative or adjunct blanket infrared filter layer for a portion of, or in the alternative of, the blanket planarizing layer 18.

Thus, a blanket infrared filter layer formed in accord with the present invention may be formed within any of several locations interposed between: (1) a substrate having formed therein a photoactive region which is sensitive to infrared radiation; and (2) a microlens layer formed over the substrate having formed therein the photoactive region which is sensitive to infrared radiation and in registration with the photoactive region which is sensitive to infrared radiation, but typically and preferably not directly upon the substrate, and further wherein in addition to providing an infrared filter function within an optoelectronic microelectronic fabrication the blanket infrared filter layer also provides a planarization function and/or an optical spacing function within the optoelectronic microelectronic fabrication.

### EXAMPLES

There was fabricated a color filter diode sensor array optoelectronic microelectronic fabrication generally in accord with the color filter diode sensor image array optoelectronic microelectronic fabrication whose schematic cross-sectional diagram is illustrated in FIG. 1, while employing materials and dimensions as are generally outlined within the Description of the Preferred Embodiment. In particular, the color filter diode sensor image array optoelectronic microelectronic fabrication employed a blanket spacer layer formed of a methacrylate resin spacer material, equivalent to the blanket spacer layer 22 as illustrated within the color filter diode sensor image array optoelectronic microelectronic fabrication whose schematic cross-sectional diagram is illustrated in FIG. 1, formed to a thickness of about 16000 angstroms.

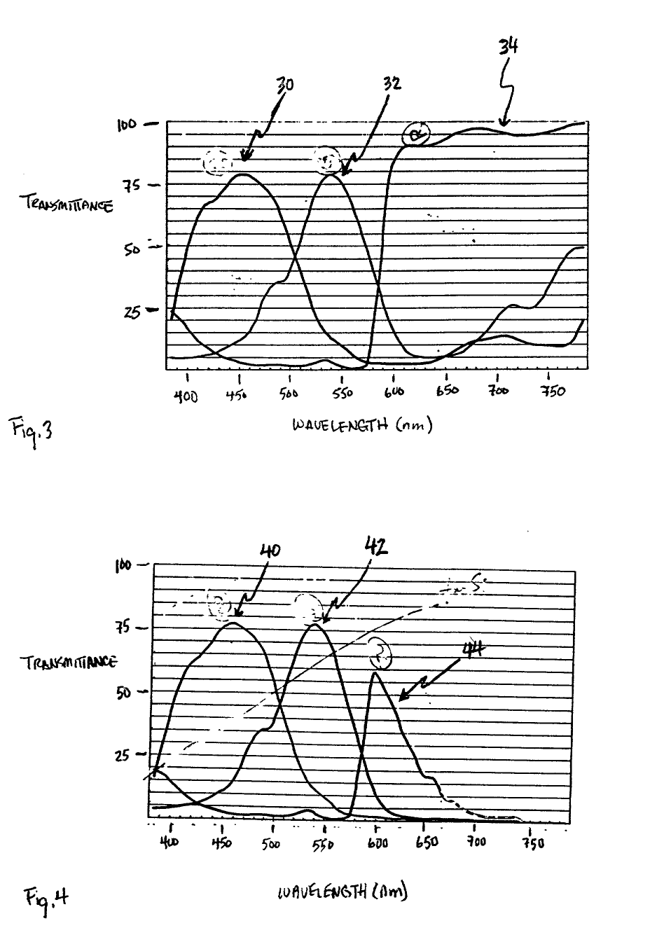

There was then the color filter diode sensor image array optoelectronic microelectronic fabrication a spectral sensitivity with respect to each of the three colors—blue, green and red—employed within the color filter diode sensor image array optoelectronic microelectronic fabrication. The resulting spectral sensitivities are shown within the graph of FIG. 3, which shows a plot of Transmittance versus Wavelength for each of the three colors. Within the graph of FIG. 3, the curve which corresponds with reference numeral 30 corresponds with the optical sensitivity of the blue color filter layers, the curve which corresponds with reference numeral 32 corresponds with the optical sensitivity of the green color filter layers and the curve which corresponds with reference numeral 34 corresponds with the optical sensitivity of the red color filter layers.

As is seen from review of the graph of FIG. 3, there is limited spectral sensitivity within the color filter diode sensor image array optoelectronic microelectronic fabrication with respect to the red color filter layers, in particular with respect to infrared transmittance of the red color filter layers.

For comparison purposes, there was also fabricated a color filter diode sensor image array optoelectronic microelectronic fabrication in accord with the color filter diode sensor image array optoelectronic microelectronic fabrication whose schematic cross-sectional diagram is illustrated in FIG. 2, wherein a blanket spacer layer, such as the blanket spacer layer 22, was instead replaced with a thinned blanket spacer layer, such as the thinned blanket spacer layer 22′, of thickness about 16000 angstroms and formed of a methacrylate resin, where the thinned blanket spacer layer 22′ in turn had formed therebeneath a blanket infrared filter layer, such as the blanket infrared filter layer 21, of thickness about 10000 angstroms, and further wherein the blanket infrared filter layer was formed of a spin-on polymer (SOP) infrared filter material available as an infrared filter material available from JSR.

There was then a spectral sensitivity with respect to each of the three colors—blue, green and red—employed within the infrared filtered color filter diode sensor image array optoelectronic microelectronic fabrication. The resulting spectral sensitivities are shown within the graph of FIG. 4, which shows a plot of Transmittance versus Wavelength for each of the three colors.

Within the graph of FIG. 4, the curve which corresponds with reference numeral 40 corresponds with the optical sensitivity of the blue color filter layers, the curve which corresponds with reference numeral 42 corresponds with the optical sensitivity of the green color filter layers and the curve which corresponds with reference numeral 44 corresponds with the optical sensitivity of the red color filter layers.

As is seen from review of the graph of FIG. 4 in comparison with the graph of FIG. 3, there is substantially improved spectral sensitivity within the infrared filtered color filter diode sensor image array optoelectronic microelectronic fabrication, particularly with respect to the red color filter layers, in particular with respect to an attenuated infrared transmittance of the red color filter layers.

Thus, in accord with the objects of the present invention, the present invention provides an optoelectronic microelectronic fabrication, and more particularly a color filter diode sensor image array optoelectronic microelectronic fabrication, with enhanced optical sensitivity.

As is understood by a person skilled in the art, the preferred embodiment and examples of the present invention are illustrative of the present invention rather than limiting of the present invention. Revisions and modifications may be made to methods, materials, structures and dimensions through which is provided an optoelectronic microelectronic fabrication in accord with the preferred embodiment and examples of the present invention while still providing an optoelectronic microelectronic fabrication in accord with the present invention, further in accord with the accompanying claims.

What is claimed is:

1. An optoelectronic microelectronic fabrication comprising:
a substrate having formed therein a minimum of one photoactive region which is sensitive to infrared radiation;
a minimum of one microlens layer formed over the substrate and in registration with the minimum of one photoactive region; and
a minimum of one infrared filter layer formed interposed between the substrate and the minimum of one microlens layer, wherein the minimum of one infrared filter layer is not formed contacting the substrate.

2. The optoelectronic microelectronic fabrication of claim 1 wherein the optoelectronic microelectronic fabrication is selected from the group consisting of sensor optoelectronic microelectronic fabrications and display optoelectronic microelectronic fabrications.

3. The optoelectronic microelectronic fabrication of claim 1 wherein the optoelectronic microelectronic fabrication is selected from the group consisting of sensor image array optoelectronic microelectronic fabrications and display image array optoelectronic microelectronic fabrications.

4. The optoelectronic microelectronic fabrication of claim 1 wherein the infrared filter layer is formed to a thickness of from about 10000 to about 15000 angstroms.

5. The optoelectronic microelectronic fabrication of claim 1 wherein the infrared filter layer is formed of a spin-on-polymer (SOP) infrared filter material.

6. The optoelectronic microelectronic fabrication of claim 1 wherein the infrared filter layer serves simultaneously as an optical spacer layer.

7. The optoelectronic microelectronic fabrication of claim 1 wherein the infrared filter layer serves simultaneously as a planarizing layer.

8. A method for fabricating an optoelectronic microelectronic fabrication comprising:
providing a substrate having formed therein a minimum of one photoactive region which is sensitive to infrared radiation;
forming over the substrate and in registration with the minimum of one optically active region a minimum of one microlens layer; and
forming interposed between the substrate and the minimum of one microlens layer an infrared filter layer, wherein the infrared filter layer is not formed contacting the substrate.

9. The method of claim 8 wherein the optoelectronic microelectronic fabrication is selected from the group consisting of sensor optoelectronic microelectronic fabrications and display optoelectronic microelectronic fabrications.

10. The method of claim 8 wherein the optoelectronic microelectronic fabrication is selected from the group consisting of sensor image array optoelectronic microelectronic fabrications and display image array optoelectronic microelectronic fabrications.

11. The method of claim 8 wherein the infrared filter layer is formed to a thickness of from about 10000 to about 15000 angstroms.

12. The method of claim 8 wherein the infrared filter layer is formed of a spin-on-polymer (SOP) infrared filter material.

13. The method of claim 8 wherein the infrared filter layer serves simultaneously as an optical spacer layer.

14. The method of claim 8 wherein the infrared filter layer serves simultaneously as a planarizing layer.
